(19) United States
(12) Patent Application Publication
(10) Pub. No.: US 2024/0220884 A1
(43) Pub. Date: Jul. 4, 2024

(54) METHOD FOR REMOTE MANAGEMENT OF COUNTER SERVICES AND RELATED WEB PLATFORM

(71) Applicant: INNOVATION DEVELOPMENT ADVANCED SOLUTIONS - |.DE.A.S. S.R.L., Isernia (IT)

(72) Inventor: Franco IANNELLI, Isernia (IT)

(21) Appl. No.: 18/288,814

(22) PCT Filed: Apr. 28, 2022
(86) PCT No.: PCT/IB2022/053954

§ 371 Date: Oct. 29, 2023

(30) Foreign Application Priority Data
Apr. 28, 2021 (IT) 102021000010724

(51) Int. Cl. G06Q 10/0631

(52) U.S. Cl. CPC G06Q 10/063118

(57) ABSTRACT

A web platform for the remote management of counter services comprises and carries out a plurality of services that can traditionally be provided but through WEB access and can be implemented according to the requests of potential customers; the system manages both counters for the provision of different services, and different types of companies, and a web portal for managing requests for access to sessions and queues in a plurality of functions designed to be selectively provided by said web counters. The system structure can manage 2500 per single cloud server and also allows to optimize the operators according to the place from which they are called by the IP Web, according to the service, to help with critical queues that are too long or even for out-of-hours optimizations of additional resources.

### TECHNICAL FIELD

The present invention finds application in the field of communication devices and it particularly relates with a method for the remote management of counter services. The invention also has as its object a web platform designed to carry out the above method.

### STATE OF THE ART

As known, to carry out counter operations, in any area, the most common solution still involves physically going to a counter located inside an office reserved for supplying a limited type of service.

This solution has a multiplicity of obvious drawbacks, related in particular to the overall time required to go to the counter, wait in the queue for own turn, receive the service and return to own home or workplace.

In addition, the physical counters provide services that are homogeneous by type and do not allow to receive services of different types, so if there is a need to receive different services, it is necessary to go to several counters also located in distant places. To overcome at least in part these drawbacks, particular IT units have been introduced for the delivery of information and/or documents to citizens, also commonly called “totem” in jargon, which are applied in various sectors, both in the public and in the private sector, to provide specific services to the user.

In particular, the totems allow a user to receive information about a specific service and possibly allow the printing of documents or the sending of information by the same user to a central manager, without the need for the presence of an operator.

These units or totems are often used in public offices, such as registry offices, schools and universities, and allow to receive specific or generic information and possibly print official documentation.

It is clear how similar systems, essentially static, are severely limited in functionality, not allowing the user to receive a personalized service that goes beyond the information preset inside the machine.

It follows that for the provision of specific and more complex services, such as, for example, an installment payments request to a collection agency, carry out checks, accept payments and issue receipts or other types of requests for a service that can be customized according to the needs of the user, it is always necessary to go to a physical counter manned locally by an operator.

However, for service providers, be they public bodies or private entities, it is not always possible to set up a counter service that operates continuously or in any case for the normal hours and days of opening, i.e. eight hours a day, five days a week.

In particular, in locations with few inhabitants or for services with a relatively limited number of potential users, it may not be economically justified or in any case sustainable to set up a local counter that is always manned for the entire office hours.

It follows that it is often necessary to combine several local counter services in a single centralized counter or to limit the operation of individual local counters, reducing the opening hours and/or the number of days per week, in any case resulting in a disadvantage for the user.

To this aim, remote counter services have been introduced which allow a user to interact remotely with an operator and which fully reproduce the functions of a physical counter, including the possibility of receiving documents and signing the documentation.

The main drawbacks of these solutions reside first and foremost in the need to go to a room where there is a local counter through which to contact the operator.

In addition, the remote counter could be implemented to provide a single type of service or a series of interrelated services.

Further technical problems related to this kind of services provided remotely, i.e. totems, reside in the impossibility for a user to resume at a later time a session started previously and which was interrupted due to user needs or due to of technical problems.

### Scope of the Invention

The object of the present invention is to overcome the above drawbacks by providing a method for the remote management of counter services and the related web platform which are characterized by high efficiency and relative cost-effectiveness.

A particular object is to provide a method and the related web platform for the remote management of all types of counter services that allow the user to remotely access any service, such as a consultancy or service for supplying or sending documents or any other type of service commonly provided by a public or private subject, always allowing to communicate with an operator in a substantially identical manner to what would happen in a traditional physical counter.

Still another object is to provide a method and the related web platform for the remote management of counter services which allow a user to receive a multiplicity of services, even of a different nature, and which would normally require the user to go to several separate offices.

Still another object is to provide a method and the relative web platform for the remote management of counter services which allow the user to access a service without time or place limitations.

Still another object is to provide a method and the relative web platform for the remote management of counter services which allow the user to carry out the same session in several moments.

Not least object is to provide a method and the related web platform for the remote management of all types of counter services and which allow the provision of services in a safe manner for both the user and the provider.

These objects, as well as others that will become more apparent hereinafter, are achieved by a method which, in accordance with claim 1, comprises the steps of providing a plurality of remote office stations for the provision of respective counter services, providing a web portal for managing requests for a plurality of counter services designed to be selectively provided by said remote office stations, sending from respective one or more users to said web portal of one or more requests for the provision of one or more of said counter services, wherein said web portal is adapted to organize said requests according to respective queues homogeneous by type of requested service and/or according to the geographical location indicated or detected for each of said one or more users and to send them to said one or more of said remote offices according to their availability.

Furthermore, according to claim 9, a web platform is provided for the remote management of counter services which comprises a plurality of offices for supplying respective counter services, a web portal for managing requests for a plurality of counter services suitable to be selectively supplied by said offices, a plurality of communication devices associated with respective users and adapted to connect via web with said web portal to send a supply request of one or more of said counter services, wherein said web portal is adapted to organize said requests according to respective queues homogeneous by type of requested service and/or according to the geographical location indicated or detected for each specific user.

The web platform will allow to have a direct relationship between user and operator in a similar way to a traditional physical counter, but without the need to physically go to this counter, also allowing to connect to several different counters to perform multiple queues at the same time.

The dematerialization of the counter function, both on the operator side and on the user side, also allows to review a whole series of typical paradigms of physical counters: first of all the fixed counter hours can be totally modified or even be provided continuously, even on holidays or days before holidays, as well as outside traditional hours, without representing an additional cost as it will be possible to take advantage of workshifts and flexible hours.

The platform allows to access totally different services, provided in different offices without having to move from home but simply by requesting the service of interest on a dashboard that appears at the beginning of the web session when you queue, in order to not to create unnecessary gatherings in the offices and allowing to arrive only at the right time at the counter to deal with their practices, so as to guarantee high safety for both the user and the staff of the counter, who can also operate remotely and in so-called homeworking or smartworking mode.

The platform will allow to increase the efficiency of the branches thanks to the possibility of dynamic interchange of the different operators with respect to a certain number of offices, depending on the queue, the request, the number of people queuing for a specific service, allowing to alternate operators so as to also cover timetables outside the normal traditional counter hours.

The web platform configured in this way will make it possible to provide all the services that can traditionally be provided, but through web access.

The services will be implemented according to the requests of potential customers and the platform may allow to manage both offices for the provision of various services to the citizen and for different types of companies.

The structure of the platform will allow to manage 2500 operators per single cloud server, modular and scalable, and also has the possibility of optimizing operators according to the region from which you are called by the IP Web (for example dialect or familiarity with the idiomatic feature of the territory), of the requested service, to help with critical issues of too long queues or even for out-of-hours optimization of additional resources.

The platform will make it possible to provide services with maximum flexibility of delivery and use, will constitute a dynamic and scalable system and will replicate all the functions of traditional offices, not limited to a simple videoconferencing system.

### BRIEF DISCLOSURE OF THE DRAWINGS

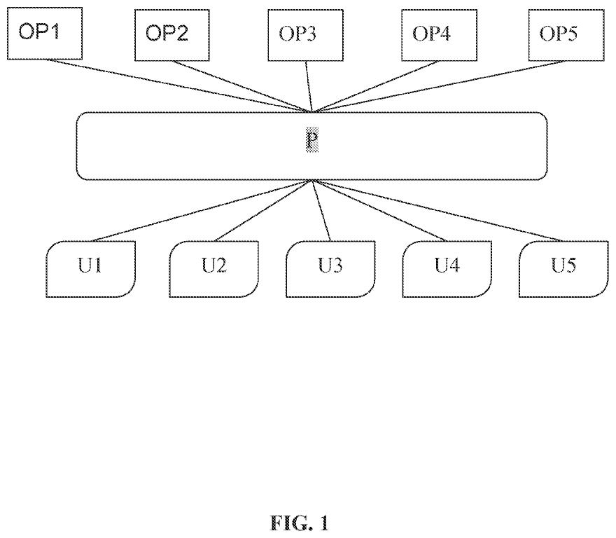

Further features and advantages of the invention will become more apparent in the light of the detailed description of preferred but not exclusive embodiments of the web platform according to the invention, illustrated by way of non-limiting example with the aid of the accompanying drawing tables wherein FIG. 1 is a schematic view of the system.

### BEST MODES OF CARRYING OUT THE INVENTION

As shown in FIG. 1, the web platform for the remote management of counter services essentially consists of a plurality of remote counters or offices OP1, OP2, OP3, . . . for the provision of respective counter services, a web portal P for the centralized management of requests for the provision of a plurality of counter services designed to be selectively provided by the counters and of a plurality of communication devices U1, U2, U3, . . . associated with respective users and adapted to connect via web with the web portal P for sending a request for the provision of one or more of the above counter services.

The term “remote” means that the counters are located in environments distant from the users in such a way that users cannot communicate with the counter operators except through electronic communication devices.

Furthermore, each remote counter will be designed to provide its services through the Internet network or through further possible remote data transmission and exchange systems, even of the type that does not currently exist, and therefore will also be referred to below as web counters.

Each of the remote counters OP1, OP2, OP3, . . . may be used to supply one or more services, even different from each other but usually homogeneous by type, without particular limitations in number and type.

In addition, each remote counter may be associated with one or more operating stations manned by respective operators, who can alternate in the provision of the same service or operate in parallel or, again, be associated from time to time with a different counter. The counter operators may be either natural persons or automated and computerized systems, possibly managed by artificial intelligence or bots for any repeated sessions of routine counter operations.

The web portal P is designed to organize the requests for the provision of the various services by all users U1, U2, U3 connected from time to time according to their queues homogeneous by type of requested service, also based on the type of services that each remote counter OP1, OP2, OP3 is suitable to supply.

The web portal P will be accessible by each user through the websites of the providers of the specific service to be provided, which for this purpose will provide a specific interface or link for direct connection to the web portal.

The web portal P is provided with a dashboard designed to list the services that can be supplied and to indicate, for each of these services, the number of users in the respective queue.

In addition, the dashboard is provided with a preliminary identification system of the user by the entering by the same of user an alphanumeric code, such as his/her own telephone number and/or tax code.

In this way, the dashboard may manage a plurality of queues relating to the same user and relating to different selected services by means of the same preliminary identification code, as will become clearer below by means of an operational example.

The web portal is also provided with an integrated communication system via SMS or other instant messaging system, also via push notification, suitable to dynamically generate a text message to be sent to the communication devices for sending information relating to the position in the respective queue.

Furthermore, the web portal is adapted to add a voice module to the same database of instant messages for the generation of audio messages which is adapted to be reproduced by means of an interactive telephone call between the communication devices and the web portal.

In particular, the web portal will operate through one or more servers that will allow the flow of information, which may include both simple data and dematerialized documents or, again, images and/or videos, between users and remote offices.

Advantageously, the data flow will be such that the exchange of information takes place directly between the endpoints of each session, i.e. directly between the user (and therefore the communication device with which he/she is provided) and the remote counter which the session has been assigned to, without going through the server.

This feature will ensure maximum security and respect for users' privacy as no information will be stored on the servers.

Advantageously, the web portal will use a combination of both STUN and TURN cloud servers to ensure that the audio/video streams are correctly routed in order to correctly create videoconferencing sessions between the counter operator and the user.

The streaming will be adaptive to adapt according to the availability of bandwidth by active users at a given moment.

According to a further particularly advantageous aspect, the system will be designed to allow the automatic recovery of unfinished sessions by the counter operator, for example if the user has to interrupt the session or there are connection problems of one of the two parties.

To this end, each session will be assigned a unique ID that allows the above restoration and which will remain active as long as the counter operator does not indicate that the session has ended.

From an operational point of view, the web platform that will configure the web or remote counter may be reached through various communication devices and in different ways.

The communication devices that can be used are all mobile communication devices, such as mobile phones, smartphones, tablets, regardless of the respective operating system, as well as PCs, notebooks, computers of any type, both fixed and portable.

It will not be necessary, although still possible, to install a special app, as access to the web portal will be possible by accessing the website of the service provider or a specific website of the web platform from the browser.

Depending on how the offices for the access to the services are organized, you can access the services either with a simple queuing ticket, to use the service at the moment, or with a web booking for a subsequent period of time, by choosing the time window that the office makes available.

In the first hypothesis, i.e. access via ticket, the user may proceed to connect to the web platform through the web page of the specific service provider, selecting the option to access the web platform and, subsequently, selecting one or more services from those that can be provided from the selected office.

For each of the services you can queue up by displaying your own alphanumeric personal identification code, which can be your telephone number, your name or your social security number.

Subsequently, your device will display the booking ticket on the screen with indication of the position in the various queues, the estimated time and the option to leave the queue if you had to opt for a re-submission in the next queue.

At the same time an SMS or other text message will arrive via one of the typical messaging apps, or via push notification if you use a specific app for the platform, which will provide all the information relating to your position in the queue.

In the event that you opt to queue on multiple services, you will receive a series of messages with the position in the queue for each individual service, the estimated time to be received at the counter, also reporting the presence to the various offices within their queue management system.

When the web counter will admit the user to supply the service, it will be necessary to accept the privacy rules by authorizing, among other things, the use of the videoconferencing session and the management of the device's webcams.

At this point, the session begins and a curtain rises on the device screen, so that you can start talking to the operator via a video conference in HD quality.

At this point, as in a normal traditional counter session, in order to access a series of services or make requests, it will be necessary to personally identify the user by the operator.

The web platform may be provided with various secure user recognition systems, such as SPID, facial recognition, identification of an identity document, recording of a short video, also in accordance with current legislation.

At this point the operator may activate the second camera of the device to remotely scan any document to be shown and acquired, saving it in the CRM session of the counter in progress on the operator side as a normal scan to PDF.

All CRM functions are interfaced with the web platform through A.P.I. web sites that simplify all system alignment operations without ever having to deal with complicated data security instances.

In this way, moreover, the operator of the web counter may control the various functions directly through the management system assigned thereto, suitably integrated.

As reported, at the beginning of the session you are asked to accept the privacy and to accept that the video call can be managed by the remote operator.

Having accepted these conditions, the operator of the web desk, having to acquire the documents, will simply ask the user to frame the document with the rear camera of the communication device and, when the shot is clear, he/her will take a photo and will scan the document shown on his/her own system.

At this point in the operator's management system, which may be different for each service provider, he/her will carry out the normal activities for the management of the user's request.

Preferably, the document may be received by the users directly on their device, without the need to provide email addresses or other personal contact details.

All user data will be deleted at the end of the counter session for privacy reasons.

At the end of the session with the first counter, the user will return to the shared queues section which will indicate the position in the queues for the other requested services, updating the theoretical time spent in the queue, informing about the next available counter, with relative residual time, sending the related messages.

Access to the platform may also take place via web booking of a time window made available by the same provider.

The web platform organized in this way will allow you to reach multiple offices consecutively and without having to leave your home or workplace and in any case from any place where a web connection is available, eliminating all the drawbacks and risks associated with staying in crowded places.

It will also be possible for the counter operator to operate in maximum safety but without having to change operating procedures.

As matter of fact, thanks to the integration of A.P.I. it will continue to operate on its CRM program which will command the remote counter sessions with the utmost ease. The operator may also see the status of the active counters, how many people has in the queue and if he/her has to ask the supervisor to support him/her with some other resources to speed up and dispose of an excessive queue.

In addition to the function described above, the web platform will allow to implement further advanced functions to allow the provision of all types of over-the-counter services to the public, comprising digital payments.

By way of example, the platform will allow the HD scanning of documents, reading of current account bulletins, reading of tax forms, such as F24 and the like, acquisition of identification documents, FEA signature with legal value, graphometric signature, generation of receipts, making payments via POS WEB or other system designed to allow any type of payment, document recognition via one-way and two-way barcode, release of certificates and documents by downloading to acceptance on the device.

The operator will also have a series of widgets available in his/her dashboard that will allow him/her to perform the normal counter functions remotely, such as, by way of example, interaction with the user in video presence, acquisition of any documents, the reading of codes (for example QR Code and Barcode), management of both graphic and electronic signature operations, delivery of documents, management of payments.

Among the features available to the user who accesses the web desk, the following may be provided:
acquisition via camera of the electronic device of the documents that the user must present to the counter operator or, alternatively, upload to the operator's endpoint, of documents, only of authorized format, to be delivered at the counter;
extrapolation through special image analysis software of any QRCode or Barcode present on the documents uploaded by the user; the data extracted from the image will then be available to the operator for copying/pasting;
visual recognition for user identification by performing the audio/video recording of the session with replacement of the same according to law;
return of documents to the user, always in the authorized format (for example PDF), through selection by the operator from his PC or other processor and direct sending to the user's endpoint via download on the electronic device used by the user for video call.

1. A method for the remote management of counter services, comprising the following steps:
a) provision of a plurality of remote offices or counters (OP1, OP2, OP3) for supplying respective services;
b) provision of a web portal (P) for managing requests for a plurality of counter services suitable to be selectively provided by said remote counters (OP1, OP2, OP3);
c) sending by respective one or more users to said web portal (P) of one or more requests for supplying of one or more of said counter services;
wherein said web portal (P) is adapted to organize said requests according to respective queues homogeneous by type of requested service and/or according to the geographical location indicated or detected for each of said one or more users and to send them to said one or more of said remote counters (OP1, OP2, OP3) according to their availability.

2. Method as claimed in claim 1, characterized in that said requests are sent by the respective users by means of corresponding communication devices (U1, U2, U3) adapted to connect via web with said web portal (P).

3. Method as claimed in claim 2, characterized in that said web portal (P) is managed by a server adapted to assign an identification code to each of said requests.

4. Method as claimed in claim 3, characterized by the fact that said identification code is kept active until a completion command is entered from the remote counter which the request has been assigned to.

5. Method as claimed in claim 1, characterized in that said server is adapted to enable an exchange of information and/or documents between the user who sent the request and the remote counter which the request has been assigned to.

6. Method as claimed in claim 5, characterized in that said exchange of information and/or documents takes place directly between said user and said remote counter avoiding data passing from said server.

7. Method as claimed in claim 1, characterized in that said portal is adapted to regulate the flow of information between said remote counters and users by using a combination of STUN and TURN cloud servers.

8. Method as claimed in claim 7, characterized in that said flow of information is of the adaptive type to adapt it to the band availability of the users.

9. Web platform for the remote management of counter services, characterized by comprising:
a plurality of counters or offices (OP1, OP2, OP3) for supplying respective services;
a web portal (P) for managing requests for a plurality of services adapted to be selectively provided by said counters (OP1, OP2, OP3);
a plurality of communication devices (U1, U2, U3) associated with respective users and adapted to connect via web with said web portal (P) to send a request for the provision of one or more of said services by one or more of said counters (OP1, OP2, OP3):
wherein said web portal (P) is adapted to organize said requests according to respective queues homogeneous by type of requested service and/or according to the geographical location indicated or detected for each specific user.

10. Web platform as claimed in claim 9, characterized in that said web portal (P) is accessible by each user through the websites of the providers of the specific service to be provided.

11. Web platform as claimed in claim 9, characterized in that said web portal (P) is provided with a dashboard adapted to list the counter services available to the supply by said counters (OP1, OP2, OP3) and to show, for each of said counter services, the number of users in the respective queue.

12. Web platform as claimed in claim 11, characterized in that said dashboard is provided with a preliminary identification system of the user by entering an alphanumeric code, such as telephone number, tax code, and is adapted to manage a plurality of queues relating to the same user by means of the same preliminary identification code.

13. Web platform as claimed in claim 9, characterized in that said web portal (P) is provided with an integrated communication system by means of SMS or other instant message adapted to dynamically generate a text message to be sent to said communication devices (U1, U2, U3) for sending information about the position in the respective queues.

14. Web platform as claimed in claim 13, characterized in that said web portal (P) is adapted to add a voice module to the same database of said instant messages for the generation of audio messages to be reproduced by means of communication or interactive telephone call between said communication devices (U1, U2, U3) and said web portal (P).

15. Web platform as claimed in claim 9, characterized in that said communication devices (U1, U2, U3) are selected from the group comprising mobile phones, smartphones, tablets, PCs, computers and the like.

16. Web platform as claimed in claim 15, characterized in that said communication devices (U1, U2, U3) are provided with means for the acquisition of images and videos.

17. Web platform as claimed in claim 16, characterized in that said communication devices (U1, U2, U3) are provided with a first camera suitable for allowing user identification and a second camera for acquisition of images and/or videos of documents, said web portal (P) allowing said counters (OP1, OP2, OP3) to control said second camera for the autonomous acquisition of said images and/or videos.

18. Web platform as claimed in claim 1, characterized in that said web portal (P) is provided with means of secure identification of the users.
